(19) United States
(12) Patent Application Publication
(10) Pub. No.: US 2003/0020979 A1
(43) Pub. Date: Jan. 30, 2003

(54) Remote optical transmitter output power control

(76) Inventor: John Arnold Bell, Long Beach, CA (US)

Correspondence Address: Kyshon Rivers, Outside Counsel Coordinator, Agere Systems, Inc, 600 Mountain Avenue, Room 3A 506, Murray Hill, NJ, 07974-0636, US

(21) Appl. No.: 09/918,037

(22) Filed: Jul. 30, 2001

(51) Int. Cl. H04B 10/08; H04B 10/00

(52) U.S. Cl. 359/110; 359/172

(57) ABSTRACT

A device and method for remotely monitoring and changing the performance characteristics of one or more of the components of an optical transponder system using a microcontroller. Remote access allows users to remotely monitor and change various performance characteristics of the transponder. Threshold performance levels of the components are determined and set. When the microcontroller determines that one or more of the threshold levels have been exceeded, it sets off an alarm and the microcontroller can then be used to modify the particular performance characteristic.

### BACKGROUND OF THE INVENTION

1. Field of the Invention

The present invention relates to optical transmission systems and an apparatus to control the systems remotely. For example, and without limiting its scope, the present invention can be used in connection with a wavelength division multiplexed transmission system.

2. Description of the Prior Art

A system for transmitting multiple optical signals is well known in the prior art. A series of transmitters in the form of a laser array 1 transmits a series of signals or wavelengths designated as λ1 through λn. The optical output of each transmitter is then fed through an equal number of attenuators 2 identified as Att 1 through Att n. The optical output of each attenuator is then fed through an equal number of optical fibers 3 to a single optical multiplexer 4 which combines all of the separate wavelengths of each separate transmitter in the laser array 1 into one single optical fiber 5. If necessary, the signal in optical fiber 5 is amplified by an optical amplifier 6. At the end of the transmission, the multiplexed and amplified signal is transmitted through another optical fiber 7 to an optical demultiplexer 8 which demultiplexes each wavelength to separate fibers 9 which then transmits each of the demultiplexed signals to receiver arrays 10 which are a series of detector/receivers which recover the optical signals and convert them back into an electrical signal.

There are a number of problems with the above-described prior art system. First, although the individual laser transmitters of the laser transmitter arrays 1 are typically manufactured by the same manufacturer to the same specifications, the transmitter output of each laser is not always the same. In fact, their outputs can vary as much as 50% and still be within the manufacturer's specifications. Despite the variations in output of the individual laser transmitters in laser transmitter arrays 1, manufacturers set the outputs of the lasers at the factory and design the transmitters so that the output cannot be changed by the users/purchasers of the laser transmitters. The manufacturers prevent access to the internal controls of the transmitters because they are very sensitive and easily damaged. If unauthorized personnel damage the internal controls, the warranties are rendered worthless. Similarly, the multiplexers have tolerances which vary from multiplexer to multiplexer.

Because of the above-described variations in laser transmitters and multiplexers, purchasers/users of laser transmitters may need to have the transmitters' output powers slightly changed. In the prior art, the attenuator arrays 2 are used to adjust for the variations. That is, each individual attenuator in the attenuator arrays 2 must be adjusted on-site in order to reduce the signals coming from the individual transmitters. This reduction (or control) of each individual transmitter's output power by the attenuators is necessary so that each transmitter's power, after being combined by optical multiplexer 4, is roughly the same. The optical multiplexer (and demultiplexer) are also wavelength sensitive. In an effort to conserve as much transmitter power as possible entering the transmit fiber 5, it is sometimes beneficial to have each transmitter's wavelength slightly varied to compensate for some of the optical multiplexer's manufacturing errors/tolerances.

Similar problems can develop as the signals pass through the optical amplifier 6 because it may amplify one signal (for example, the color red) more than another signal (for example, the color blue). Again, the optical demultiplexer 9 has similar tolerance variations as the multiplexer 4. The attenuator array 2 is the only place in the prior art system that can be varied.

There is therefore a need for a system which allows remote access to the various components of a telecommunications system and which obviates the need to have someone at the site of the transmitters, or at the site where other components are located, in order to make adjustments.

### SUMMARY OF THE INVENTION

The present invention is directed to a telecommunications system which allows remote access to the various components of a telecommunications system; for example, allowing remote access to the transmitters, receivers, multiplexers, demultiplexers, limiting amplifiers, and other optical components. Such remote access allows the users to remotely monitor and change such performance characteristics as the transmitter output power, its wavelength, and the performance characteristics of other optical components of the system.

An advantage of an embodiment of the present invention is that is allows a user of the system to remotely monitor many performance characteristics of the various optical components of the system and to remotely modify one or more of them.

### BRIEF DESCRIPTION OF THE DRAWINGS

FIG. 1 is a schematic diagram of a prior art dense wavelength division multiplexed optical transmission system.

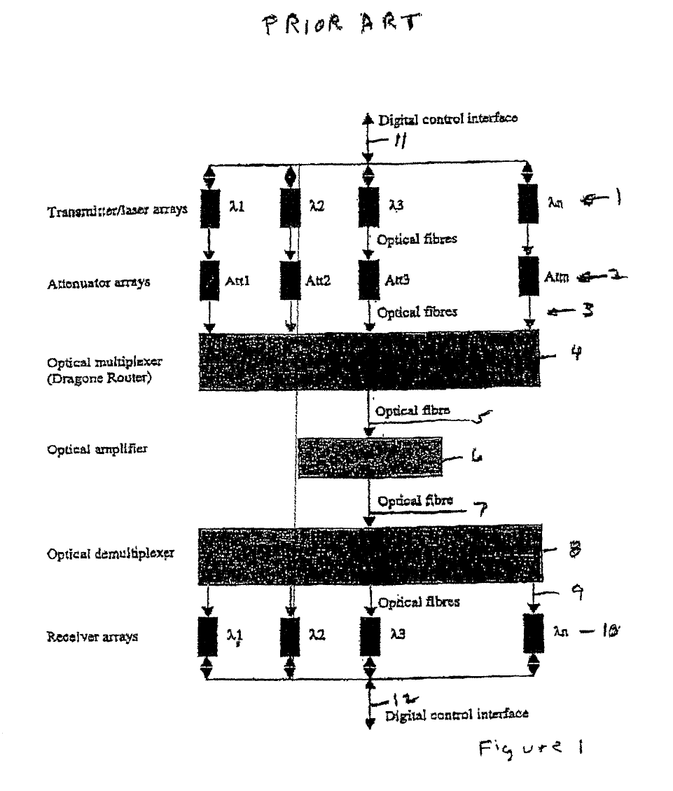

FIG. 2 is a schematic diagram of a transponder according to the present invention.

### DETAILED DESCRIPTION OF THE INVENTION

The invention will be understood more fully from the detailed description given below and from the accompanying drawings of embodiments of the invention which, however, should not be taken to limit the invention to those specific embodiments, but are for explanation and understanding only.

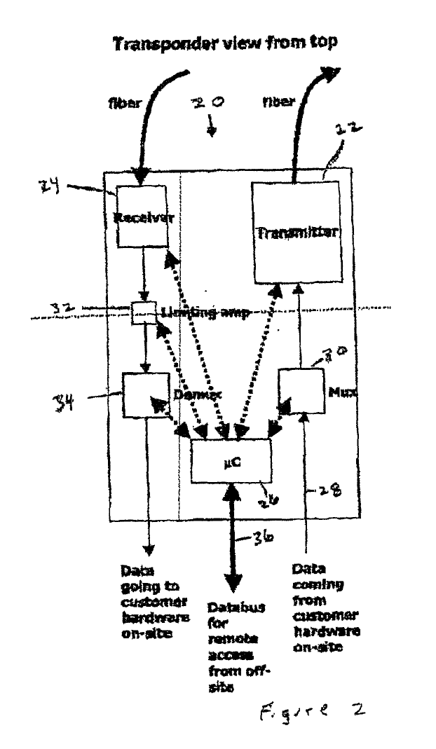

Referring to FIG. 2, there is shown a transponder 20 including a transmitter 22 and a receiver 24. Data to control transmitter 20 typically is supplied via input connections 28 and multiplexer 30. Receiver 24 sends data out from transponder 20 via limiting amplifier 32 and demultiplexer 34. The transponder also contains a microcontroller 26 which is connected to transmitter 22, receiver 24, limiting amplifier 32, and demultiplexer 34. The connections from microcontroller 26 to transmitter 22, multiplexer 30, receiver 24, limiting amplifier 32, and demultiplexer 34 allow it to monitor and control them. Microcontroller 26 has a databus 36 which allows a user to have remote access from an off-site location. Via the remote access, a user is able to monitor each of the components of the transponder and to control each of them. The connection from databus 36 to the offsite location may be accomplished by hardware and software that is well known to those of ordinary skill in the art.

In order to monitor or alter the performance of transmitter 22, for example, a command is sent via databus 36 to microcontroller 26 which receives and acknowledges the command. The command may be sent via any protocol which is well known to those of ordinary skill in the art. When microcontroller 26 receives the appropriate command, it monitors, by reading, the electrical voltage or current information from the transmitter and provides the information back out along data bus 36 to the user via a protocol which will be known to one of ordinary skill in the art. Examples of performance characteristics that can be monitored by a user through the microcontroller are laser output optical power, laser bias current, and laser temperature.

If the monitoring reveals that the transmitter performance needs to be changed, the user may send a command to the microcontroller 26 in the transponder 20 via databus 36. The microcontroller 26 receives and acknowledges the command and then outputs the appropriate voltages or currents to the transmitter to effect the necessary changes. Examples of what transmitter performance characteristics that can be monitored and changed in this way are transmitter wavelength, output power, extinction ratio, and pulse shape. To make sure the changes have actually been implemented, the user can invoke the monitor command to the microcontroller 26 for confirmation. Alternatively, microcontroller 26 could perform the monitor check automatically.

Various digital alarm signals could also be associated with transmitter 22. To accomplish the alarm signals, threshold levels could be set for the performance characteristics described above that can be monitored: for example, transmitter wavelength, output power, extinction ratio, and pulse shape. If the transmitter's performance characteristic being monitored rises above the threshold level, the alarm will be triggered, it will be sensed by microcontroller 26, and a signal will be sent to the remote user through databus 36.

As an alternative embodiment, the alarm threshold levels can be set in the microcontroller's software. If this alternative is used, the threshold levels can be changed at will. As another alternative embodiment, the threshold levels could be set by the microcontroller in hardware separate from the microcontroller. In this embodiment, the user instructs the microcontroller to alter the threshold level of the external hardware. The hardware could have the threshold levels altered by using the microcontroller to output the appropriate voltages or current levels to the hardware.

The system shown also allows the user to monitor or alter the performance of the receiver 24. To do so, a command is sent from the user to the transponder 20 via an accepted protocol which is known to those of ordinary skill in the art. At the transponder, the command is received and acknowledged by microcontroller 26 which reads electrical voltage or current information from the receiver and sends coded information to the user via databus 36 via an accepted protocol known to those having ordinary skill in the art. An example of a performance characteristic that can be monitored on a receiver is its incoming optical power.

If a receiver performance characteristic needs to be changed, a command is sent from the user to the transponder 20 via the microcontroller 26 which receives and acknowledges the command. The microcontroller 26 then sends the appropriate voltages or current levels to the receiver 24. An example of a performance characteristic that can be changed is the receiver voltage supply. To make sure the changes have actually been implemented, the user can invoke the monitor command for confirmation or the microcontroller can perform the monitor check automatically.

Various alarm signals can also be associated with receiver 24. To accomplish the alarm signals, threshold levels can be set for the values described above which can be monitored. If the receiver's threshold variable being monitored rises above the threshold level, the alarm will be triggered, it will be sensed by microcontroller 26, and a signal will be sent to the remote user through databus 36.

As an alternative embodiment, the alarm threshold levels associated with receiver 24 can be set in the microcontroller's software, thereby allowing the user to alter the threshold levels at will. As another alternative embodiment, the threshold levels can be set by the microcontroller 26 in hardware separate from the microcontroller. In this embodiment, the user instructs the microcontroller to alter the threshold level of the external hardware. The hardware could have the threshold altered by using the microcontroller 26 to output the appropriate voltages or current levels to the hardware.

The system shown also allows the user to monitor and control the limiting amplifier 32, the demultiplexer 34, and the multiplexer 30. The process is performed as described above for the transmitter 22 and the receiver 24. The user sends a command to the transponder 20 via an accepted protocol, the microcontroller 26 reads the electrical voltage or current information from the component being monitored and sends the information back to the user via databus 36. An example of performance characteristics that can be monitored are the lock error alarm from demultiplexer 34 which might occur when the demultiplexer circuit can no longer lock onto the incoming electrical signal from the limiting amplifier or the receiver directly if the limiting amplifier were removed.

If the user determines that the behavior of one or more of these components needs to be changed, the user can send a command to transponder 20 via microcontroller 26. The microcontroller will then output the appropriate voltages or current levels to receiver 24. An example of a performance characteristic that can be changed in this way is the operating speed of the demultiplexer 34.

As before, digital alarm signals and threshold points may be set and monitored through databus 36 and microcontroller 26. Again, the threshold levels may be set in the microcontroller's software, thereby allowing the threshold levels to be changed at will; or the threshold levels can be set in hardware which can have the threshold level altered by using the microcontroller to output the appropriate voltages or current levels to the hardware.

The system taught by the present invention can also be used to remotely control a multitude of other optical components such as optical modulators, optical multiplexers, optical demultiplexers, optical switches, optical power splitters, optical power combines, optical amplifiers, optical polarizers, optical circultors, optical transmitters, optical laser modules, optical receivers, and optical transceivers. All of these components can benefit in a similar manner from the remote access capability. If gives the user flexibility in setting up the communications system and monitoring performance over the lifetime of each component of the system.

In cases where faults occur during the working lifetime of a component, the remote access allows for quick detection and quick changes to the system to work around the fault. This is possible because the remote access interface taught by the present invention allows the user to monitor the system 24 hours a day. It also allows for a more complex array of monitor and control functions than would be allowable without the microcontroller being designed into the transponder. Such continuous monitoring not only facilitates monitoring of the values discussed above, it can also be used to monitor the life expectancy of a transmitter. For example, transmitters typically last for 10 to 20 years. But some transmitters do fail earlier. By tracking any increases in the laser bias current monitor, the user can predict a transmitter failure before it happens because as a laser begins to die, it uses more electrical current. Therefore, monitoring the laser transmitter's current use will send a signal to the user that the transmitter must be replaced.

While the invention has been described with specificity, additional advantages and modifications will readily occur to those skilled in the art. Therefore, the invention in its broader aspects is not limited to the specific details shown and described herein. Accordingly, various modifications may be made without departing from the spirit or scope of the general inventive concepts as defined by the appended claims and their equivalents.

I claim:

1. A system for remotely controlling the output of one or more optical components comprising
(a) a first optical component;
(b) a microcontroller connected to said first optical component adapted to monitor output information from said first optical component;
(c) a databus connected to said microcontroller and adapted to convey the output information to a remote user.

2. The system of claim 1, wherein said microcontroller and said databus are adapted to allow a remote user to control the output power of said first optical component.

3. The system of claim 1, wherein the first optical component is an optical transmitter.

4. The system of claim 3, wherein said microcontroller and said databus are adapted to allow a remote user to control the output power of said optical transmitter.

5. The system of claim 3, wherein said optical transmitter includes a laser whose performance is affected by a bias current and by its temperature; and wherein said microcontroller and said databus are adapted to allow a remote user to control the laser bias current and the laser temperature of said optical transmitter.

6. The system of claim 1, wherein the first optical component is an optical receiver.

7. The system of claim 6, wherein said receiver includes a voltage supply and wherein said microcontroller and said databus are adapted to allow a remote user to control the voltage supply of said receiver.

8. The system of claim 2, wherein the system includes a second optical component consisting of a receiver.

9. A transponder including
(a) a transmitter having an output;
(b) a receiver having an output;
(c) one or more other optical components, each of which has an output;
(d) a microcontroller adapted to allow a user to remotely monitor and control one or more of the outputs of said transmitter, said receiver, and said one or more other optical components.

10. A method for remotely controlling the output of an optical component having one or more performance characteristics consisting of
(a) connecting a microntroller to said optical component;
(b) using said microcontroller to monitor one or more performance characteristics of said optical component;
(c) monitoring the one or more performance characteristics of said optical component;
(d) determining if any of the one or more performance characteristics of said optical component needs to be changed; and
(d) using said microcontroller to change the one or more performance characteristics of said optical component.

11. The method of claim 10, including the additional step of sending a command to said microcontroller instructing said microcontroller to begin the monitoring step.

12. The method of claim 11, including the additional step of receiving information back from said microcontroller.

13. The method of claim 10, including the additional step of sending a command from the microcontroller to said optical component to cause the change to the one or more performance characteristics of said optical component.

14. The method of claim 13, wherein the additional step of sending said command includes sending voltages or currents to the optical component.

15. The method of claim 13, including the additional step of causing the microcontroller to monitor the one or more performance characteristics of said optical component after said command is sent.

16. The method of claim 10, wherein said optical component comprises an optical transmitter.

17. The method of claim 10, wherein said optical component comprises an optical receiver.

18. The method of claim 10, wherein said optical component is selected from the group consisting of an optical modulator, an optical multiplexer, an optical demultiplexer, an optical switch, an optical power splitter, an optical power combiner, an optical amplifier, an optical polarizer, an optical circulator, an optical laser module, and an optical transceiver.

19. The method of claim 10, including the additional steps of setting a threshold level for said one or more performance characteristics and determining if said threshold level is reached.

20. The method of claim 19, including the additional step of creating an alarm signal for one or more of the threshold levels of said one or more performance characteristics.

21. The method of claim 20, including the additional step of triggering an alarm if one or more performance characteristic rises above its threshold level.

22. The method of claim 21, including the additional steps of using the microcontroller to sense the triggering of the alarm and using the microcontroller to send a signal to the user when the alarm is triggered.

23. The method of claim 19, including the step of changing one or more of the threshold levels.
